(19) United States
(12) Patent Application Publication
(10) Pub. No.: US 2012/0019727 A1
(43) Pub. Date: Jan. 26, 2012

(54) Efficient Motion-Adaptive Noise Reduction Scheme for Video Signals

(76) Inventors: Fan Zhai, Richardson, TX (US); Weider P. Chang, Colleyville, TX (US)

(21) Appl. No.: 13/186,439

(22) Filed: Jul. 19, 2011

Related U.S. Application Data
(60) Provisional application No. 61/366,371, filed on Jul. 21, 2010.

(51) Int. Cl. H04N 5/21

(52) U.S. Cl. 348/607; 348/E05.077

(57) ABSTRACT

A adaptive noise reduction filter is provided for reducing noise in a video signal. Each pixel in a portion of a video frame is evaluated to determine a likelihood L of impulse noise corruption to each pixel. A total number P of pixels in the video frame that have a likelihood of impulse noise corruption is determined. One of a plurality of spatial noise reduction filters is selected to use on the video frame based on the total number P and on the likelihood L of impulse noise corruption to a current pixel. A motion value for each of the pixels in the portion of the video frame may be determined and used to inhibit spatial noise reduction filtering of each pixel that has a low motion value.

### CLAIM OF PRIORITY UNDER 35 U.S.C. 119(e)

The present application claims priority to and incorporates by reference United States Provisional Application number 61/366,371, (attorney docket TI-68225PS) filed Jul. 21, 2010, entitled “Efficient Motion-Adaptive Noise Reduction Scheme for Video Signals.”

### FIELD OF THE INVENTION

This invention generally relates to noise reduction in video images.

### BACKGROUND OF THE INVENTION

Gaussian noise and impulse noise (also called salt and pepper noise in the television (TV) signal scenario) are the two most common types of noise in TV video signals. FIG. 1A is a well known test image, referred to as the “Lena picture.” FIG. 1B illustrates a typical example of a Lena picture degraded by Gaussian noise, and FIG. 1C illustrates a typical example of a Lena picture degraded by impulse noise.

Techniques for removing or reducing Gaussian noise and impulse noise have been widely studied. Typical Gaussian noise reduction schemes can be classified into LTI (linear time invariant), nonlinear filters, and more advanced techniques. LTI filters include regular FIR filter, LMMSE (linear minimum mean squared error) and Weiner filter. LTI filters usually are not sufficient since they may smooth out high frequency textures. Nonlinear filters such as median filter, its derivatives such as weighted median filter, and bilateral filter are usually more efficient and simple to implement in hardware. More advanced techniques include local adaptive LMMSE filter, wavelet-based methods (wavelet transform itself is a linear operation, but wavelet-based methods usually require either soft or hard thresholding which is a nonlinear operation), and contour based techniques.

As for impulse noise reduction, linear filters usually do not work well. Typical schemes use a median filter. Regardless of whether the filter is linear or nonlinear, such filters tend to soften pictures to some extent. The methods proposed in T. Chen, K-K. Ma, and L-H. Chen, “Tri-state median filter for image de-noising”, IEEE Trans. On Image Processing, Vol. 8, pp. 1834-1838, Dec. 1999 [Chen99] and in W. Luo and D. Dang, “An efficient method for the removal of impulse noise”, IEEE ICIP'06 [Luo06] may better handle pictures with a large amount of impulse noise.

### BRIEF DESCRIPTION OF THE DRAWINGS

Particular embodiments in accordance with the invention will now be described, by way of example only, and with reference to the accompanying drawings:

FIGS. 1A-1C illustrate various types of common noise in a test picture;

FIG. 2 is a block diagram illustrating a video system that embodies the invention;

FIG. 3 is a block diagram of a spatial noise reduction module;

FIG. 4 is an illustration of bilateral filtering using a 3×5 window;

FIG. 5 is a block diagram of a motion-adaptive noise reduction module;

FIG. 6 is a block diagram of a de-interlacing module that includes an embodiment of the invention;

FIG. 7 is a block diagram of another embodiment of a spatial noise reduction module;

FIG. 8 is a block diagram of a video processing system on a chip that includes an embodiment of the invention; and

FIG. 9 is a flow chart illustrating adaptive noise reduction.

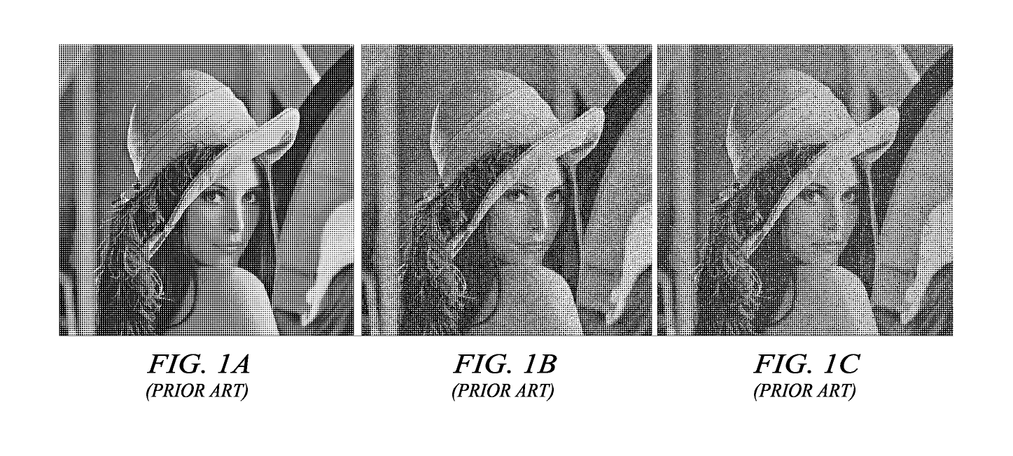

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

As discussed above, Gaussian noise and impulse noise are the two most common types of noise in TV video signals. Embodiments of the invention provide an efficient motion-adaptive noise reduction system targeting at removing, or at least reducing, these two types of noise. Reducing noise in a video stream may make use of both temporal characteristics of the video stream in a frame by frame manner and spatial characteristics of an image in a given frame.

Spatial characteristics and improved spatial filtering will be described in more detail herein. Correctly detecting which region or pixel has been affected by noise, determining what type of noise, and making the noise filters adaptive to the noise and content such as object edges, etc. provide a good performance noise filter.

Embodiments of the invention provide an adaptive spatial noise filter in which various filters are chosen according to measured noise and image content. In addition, motion between two neighboring frames may be taken into account. Spatial noise filtering may be applied to areas where motion has been detected and not applied to areas in which motion has not been detected. This adaptive technique efficiently reduces impulse noise and Gaussian noise while preserving picture details.

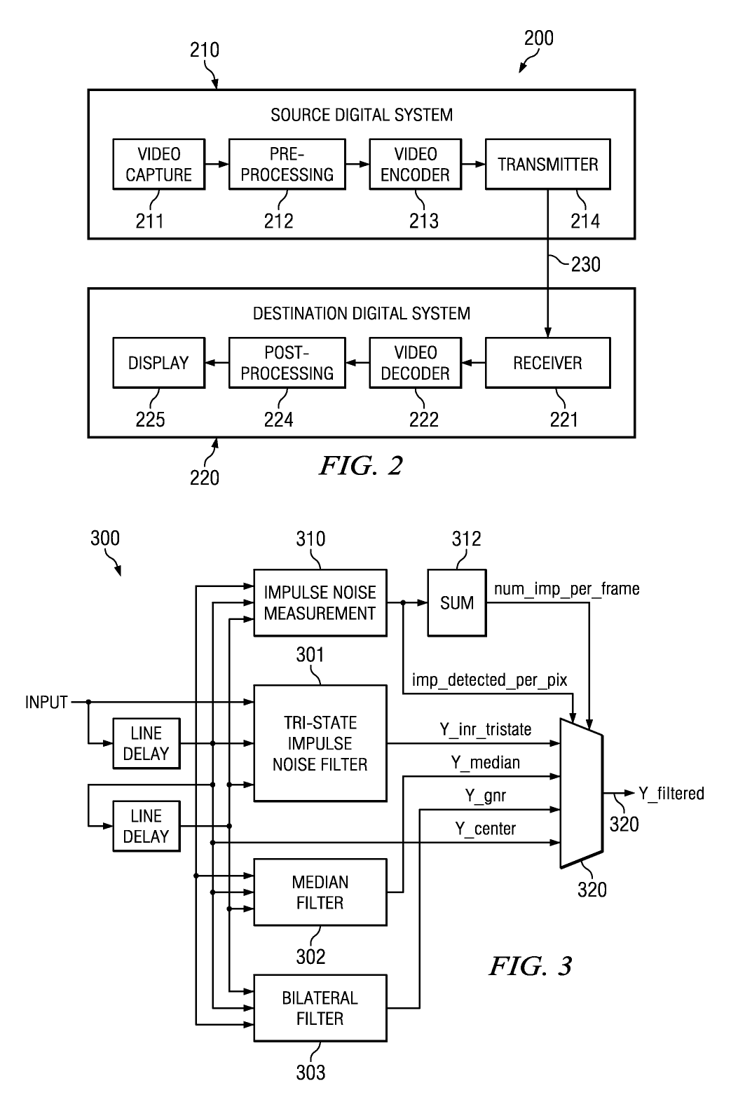

FIG. 2 is a block diagram that illustrates a high-level signal chain in an example video communication system 200. Embodiments of the invention may be applied to pre-processing module 212 in order to improve image quality and coding efficiency for video encoder 213. In another embodiment of the invention, it may be applied to post-processing module 224 for better displayed image quality.

Video system 200 includes a source digital system 210 that transmits encoded video sequences to a destination digital system 220 via a communication channel 230. The source digital system includes a video capture component 211, a pre-processing component 212, a video encoder component 213 and a transmitter component 214. The video capture component is configured to provide a video sequence to be encoded by the video encoder component. The video capture component may be for example, a video camera, a video archive, or a video feed from a video content provider, such as a cable or satellite media network. In some embodiments of the invention, the video capture component 211 may generate computer graphics as the video sequence, or a combination of live video and computer-generated video.

Pre-processing component 212 receives a video sequence from the video capture component and may perform various signal processing operations to provide noise filtering as will be described in more detail below, format conversion, etc. Video encoder component 213 receives the preprocessed video sequence and encodes it for local storage and/or transmission by the transmitter component 214. In general, the video encoder component receives the video sequence from the pre-processing component as a sequence of frames, divides the frames into coding units which may be a whole frame or a part of a frame, divides the coding units into blocks of pixels, and encodes the video data in the coding units based on these blocks.

Transmitter component 214 transmits the encoded video data to destination digital system 220 via communication channel 230. The communication channel may be any communication medium or combination of communication media suitable for transmission of the encoded video sequence, such as, for example, wired or wireless communication media, a local area network, or a wide area network.

Destination digital system 220 includes a receiver component 221, a video decoder component 222, a post-processing component 224, and a display component 225. The receiver component receives the encoded video data from the source digital system via the communication channel and provides the encoded video data to the video decoder component 222 for decoding. In general, the video decoder component reverses the encoding process performed by the video encoder component to reconstruct the frames of the video sequence. Post-processing component 224 may perform various signal processing operations on the decoded video data to perform noise filtering as will be described in more detail below, format conversion, etc. The reconstructed video sequence may then be displayed on display component 225. The display component may be any suitable display device such as, for example, a plasma display, a liquid crystal display (LCD), a light emitting diode (LED) display, etc.

In some embodiments of the invention, source digital system 210 may also include a receiver component and a video decoder component and/or the destination digital system 220 may include a transmitter component and a video encoder component for transmission of video sequences both directions for video streaming, video broadcasting, and video telephony. Further, video encoder component 213 and the video decoder component 222 may perform encoding and decoding in accordance with one or more video compression standards such as, for example, the Moving Picture Experts Group (MPEG) video compression standards, e.g., MPEG-1, MPEG-2, and MPEG-4, the ITU-T video compression standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), etc. The video encoder and pre-processing components and the video decoder and post-processing components may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

In some embodiments, video system 200 may be packaged all together in a single unit, such as in a camera. In this case, the transmitter and receiver functions may be connected to a memory system that stores the encoded video data. In another embodiment, such as a set-top box for cable or satellite applications, the transmitter and receiver components may be connected to a disk drive that stores the encoded video data for later viewing on a display that is remote from the set top box. In some embodiments, the destination digital system may be a personal device, such as a cell phone, a tablet device, a personal computer, etc.

A well designed nonlinear noise reduction filter typically incorporates edge detection and therefore usually outperforms a linear filter. However, a drawback of nonlinear filters is that if they do not perform well, they may smooth out picture details. Unlike a linear filter, the lost high frequency information due to the use of nonlinear filters cannot be easily recovered. Thus, there is higher risk in using nonlinear schemes than linear schemes for noise filtering. For this reason, in embodiments of the present invention, an amount of impulse noise is measured both locally and globally in one frame of the video data. Based on the amount of local and global impulse noise measured, a filter is selected from a set of filters to remove impulse noise within the frame. This adaptive technique will efficiently reduce impulse noise without damaging picture details. If no impulse noise has been detected, Gaussian noise reduction may then be performed. The reason to choose a Gaussian noise filter only when the impulse noise filter is not applied is because a median filter targeting at removing impulse noise is usually much stronger than a filter targeted at reducing Gaussian noise.

No matter how well a spatial noise filter is designed, it tends to soften pictures and may smooth out details. Maintaining object edges is key in image quality enhancement since human visual systems are highly sensitive to object edges. However, it is very difficult or even impossible to differentiate noise from busy picture content in some cases by only looking at the picture itself. Because of the randomness of noise, it can be easily assumed that noise affects different pictures differently. Thus, if the previous field is accessible and there is no motion (i.e., the contents of these two pictures are identical except the noise), the only difference of the two neighboring pictures will be the noise. Then it will be easy to detect the noise in a temporal manner by comparing these two pictures. For some busy areas, although the spatial-domain noise filters may tend to smooth out the details, they can be kept intact without applying the temporal noise filtering if no motion is detected. Thus, the busy areas will be identified as picture content rather than as being affected by noise by comparing the current and the previous picture. If, however, motion is detected for some areas, it will be less risky to use spatial noise filtering since moving objects, including busy details and object edges, tend to look blurred to human eyes due to the motion and therefore quality loss produced by filtering is not objectionable.

Based on these observations, improved video quality may be provided by only applying spatial noise filtering to the pixels which have motion. For areas without motion, it is better to keep the content intact. This, of course, should be a soft decision rather than a hard decision, since hard decisions may tend to introduce flickers. By doing so, it is possible to efficiently reduce noise while preserving the picture details. This method can be easily combined with temporal filtering to achieve motion-adaptive spatial-temporal noise filtering.

Impulse Noise Reduction

As mentioned above, a median filter performs very well for impulse noise reduction and thus it has been widely used. However, a median filter is a nonlinear filter and it may smooth out the details if it is not used appropriately. For example, a simple 3×3 median filter can perform very well when the amount of impulse noise is relatively small. However, when the amount of impulse noise is high, it becomes ineffective. While the methods proposed in [Chen99] and [Luo06] may better handle pictures with a great amount of impulse noise, the drawback is that it is more likely to remove picture details when the amount of impulse noise is relatively small. It should be noted that embodiments of this invention are not limited to specific implementations of impulse noise filters.

Considering the sweet zone of these different impulse noise reduction algorithms, an adaptive scheme has now been developed. A measurement module is provided which can estimate the amount of impulse noise in one frame of a picture, referred to as the global impulse noise for the frame. The likelihood that one pixel has been affected by impulse noise locally is also measured for each pixel in the frame. Based on both the global and local estimation results, one of the above-mentioned schemes is adaptively selected to remove/reduce impulse noise in the current frame. In addition, once a decision is made to perform impulse noise reduction on one pixel, Gaussian noise reduction will be disabled on this pixel for the reason discussed above.

Impulse noise measurement may be performed in 3×3 windows. In each 3×3 window, a measure is made of how many pixels are different from the center pixel by at least some threshold which is a pre-defined constant, as shown in equations (1) and (2);

$$\begin{matrix}d [ j ] [ i ] = \{ \begin{matrix}1 & if \vert Y [ j ] [ i ] - Y\_center \vert > delta\_Thr \\ 0 & otherwise\end{matrix} \\ 0 \leq j , i \leq 2 & ( 1 ) \\ num\_big \_diff = {\sum }_{i = 0}^{2} {\sum }_{j = 0}^{2} d [ j ] [ i ] & ( 2 )\end{matrix}$$

where Y_center is the center pixel, j and i are the vertical and horizontal indexes of each pixel, Y[j][i] refers to the pixel values in each 3×3 window, and delta_Thr is a pre-defined threshold. In simulations, it has been determined that setting delta_Thr to 48 led to good results for 8-bit data. If this value, num_big_diff, is greater than or equal to 7, the center pixel in this 3×3 window is marked as being affected by impulse noises, as shown in equation (3).

imp_det ected_per_pix=num_big_diff≧7?1:0 (3)

Then at the frame level, the pixels that have a likelihood of impulse noise corruption, imp_detected_per_pix, are summed for the whole frame to obtain a number of pixels that are detected as having a likelihood of being affected by impulse noise per frame, num_imp_per_frame. The num_imp_per_frame is then compared with a set of pre-defined thresholds to indicate the level of impulse noise detected for this frame. This impulse noise measurement logic is illustrated by pseudo-code in Table 1.

TABLE 1
Impulse noise measurement pseudo-code

```
/* Obtained the number of pixels being affected by impulse noise per
frame */
for (j=0; j<height; j++)
        for (i=0; i<width; i++)
              num_imp_per_frame += imp_detected_per_pix;
/* Impulse noise measurement */
if (num_imp_detected>((width*height)>>snr_inr_shift3))
        adapt_imp_mode = 3;
else if (num_imp_detected>((width*height)>>snr_inr_shift2))
        adapt_imp_mode = 2;
else if (num_imp_detected>((width*height)>>snr_inr_shift1))
        adapt_imp_mode = 1;
else
        adapt_imp_mode = 0;
```

In Table 1, snr_inr_shift1, snr_inr_shift2, and snr_inr_shift3 are three pre-defined thresholds, and snr_inr_shift1>=snr_inr_shift2>=snr_inr_shift3 must hold. Width and height are the width and height for a frame, respectively. In simulations, it has been determined that good results may be obtained when snr_inr_shift1, snr_inr_shift2, and snr_inr_shift3 are set to 8, 7, and 6, respectively. Under this setting, the first condition above can be interpreted as “more than 1/64 pixels of a frame are affected by impulse noise”, the second condition can be interpreted as “more than 1/128 pixels of a frame are affected by impulse noise”, and the third condition can be interpreted as “more than 1/256 pixels of a frame are affected by impulse noise”. It is easy to see that adapt_imp_mode=3 means that there are significant amount of pixels being affected by impulse noise, and adapt_imp_mode=0 means few pixels have been affected by impulse noise.

As mentioned above, according to the measured amount of impulse noise, different types of impulse noise reduction filters may be selected for the current frame. In one embodiment of the invention, two types of median filters may be used: a traditional 3×3 median filter and the tri-state median filter from [Chen99], which also operates at 3×3 windows. The tri-state median filter is an aggressive median filter for impulse noise reduction, so it is only used when adapt_imp_mode=3 is detected. Note that the use of a tri-state median filter for impulse noise reduction here is just an example what can be implemented in the adaptive filter scenario of embodiments of this invention. Embodiments of this invention are not limited to this specific implementation of the median filter to remove impulse noise, when a great amount of impulse noise has been detected. The traditional 3×3 median filter is used when adapt_imp_mode=1 or adapt_imp_mode=2, depending on the local impulse noise measurement result, that is, how many pixels in that 3×3 window have greater differences than delta_Thr from the center pixel. When adapt_imp_mode=0, no impulse reduction filter is used on the current frame. Instead, Gaussian noise reduction may be applied if it is allowed. For example, a video system may allow a user of the system to select from a menu or other type of prompt if the user wants Gaussian noise filtering performed on a video stream that the user is watching. The decision logic is shown in Table 2.

TABLE 2
Decision logic of spatial noise reduction.

// Note that INR output has higher priority than GNR output, if impulse
noise is detected
if ( adapt_imp_mode==3 && Y_inr_tristate!=Y_center)

| | |
|---|---|
| Y_filtered = Y_inr_tristate; | // Tri-State algorithm |

else if ( ( adapt_imp_mode==1 && num_big_diff==8)
||(adapt_imp_mode==2 && num_big_diff>=7) )

| | |
|---|---|
| Y_filtered = Y_median; | // Simple median filter |

else if (snr_gnr_enable)

| | |
|---|---|
| Y_filtered = Y_gnr; | // GNR enabled for luma |
| else | |
| Y filtered = Y center: | |

In the Table 2, snr_gnr_enable may be a register indicating whether the Gaussian noise reduction is enabled. Y_inr_tristate, Y_median, and Y_gnr are the outputs from a Tri-state median filter, a regular 3×3 median filter, and the Gaussian noise reduction filter, respectively. The Gaussian noise filter will be described in more detail below.

FIG. 3 is a block diagram of a spatial noise reduction module 300 that implements the decision logic of Table 2. In this embodiment, three types of filters 301-303 are provided. However, as mentioned above, other embodiments may provide different combinations of filters than what is illustrated here. Impulse noise measurement module 310 measures the likelihood of impulse noise corruption for each pixel of a frame, as described in Table 1. Summing module 312 tabulates a total number P of pixels in the video frame that have a likelihood of impulse noise corruption. For each frame in which global noise as indicated by P exceeds one of a set pre-selected thresholds, selector 320 selects a filter module as determined by the threshold exceeded threshold for that frame, as described in Table 1. For each pixel in the frame that is determined to have a likelihood of impulse noise corruption, the amount of local noise corruption is indicated by signal imp_detected_per_pix and is also used to control selector 320. When no local noise is detected, as indicated by imp_detected_per_pix, the unfiltered pixel Y_center is output on Y_filtered signal line 322.

Gaussian Noise Reduction

In an embodiment of this invention, a 3×5 bilateral filter is used for an efficient hardware implementation. That is, the measurement window includes three lines and five pixels on each line. A larger window size such as a 5×5 bilateral filter usually can achieve better quality but it is more expensive to implement in hardware since it requires two more line buffers if the processing image has raster scan format. Bilateral filters are edge-preserving smoothing filters in that such filters can remove or reduce the noise while maintaining the object edges. This is a factor in image/video noise reduction as human visual perception is highly sensitive to distortions of object edges. The use of a bilateral filter for Gaussian noise reduction here is just an example what can be implemented in the adaptive filter scenario of embodiments of this invention. Embodiments of this invention are not limited to this specific implementation of Gaussian noise filter. The bilateral filter implemented in this example is given below by equation (4);

$$Y\_gnr = \frac{{\sum }_{j = 0}^{2} {\sum }_{i = 0}^{4} w [ j ] [ i ] Y [ j ] [ i ]}{{\sum }_{j = 0}^{2} {\sum }_{i = 0}^{4} w [ j ] [ i ]} \\ w [ j ] [ i ] = \{ \begin{matrix}0 & if \vert Y [ j ] [ i ] - Y\_center \vert > Thr\_gnr 2 \\ 1 & if Thr\_gnr 1 < \vert Y [ j ] [ i ] - Y\_center \vert \leq \\ & Thr\_gnr 2 \\ 2 & if \vert Y [ j ] [ i ] - Y\_center \vert \leq Thr\_gnr 1\end{matrix} \qquad ( 4 )$$

where Y_center is the value of the center pixel in the 3×5 window, w[j][i] are the weights, and Thr_gnr1 and Thr_gnr2 are the two thresholds.

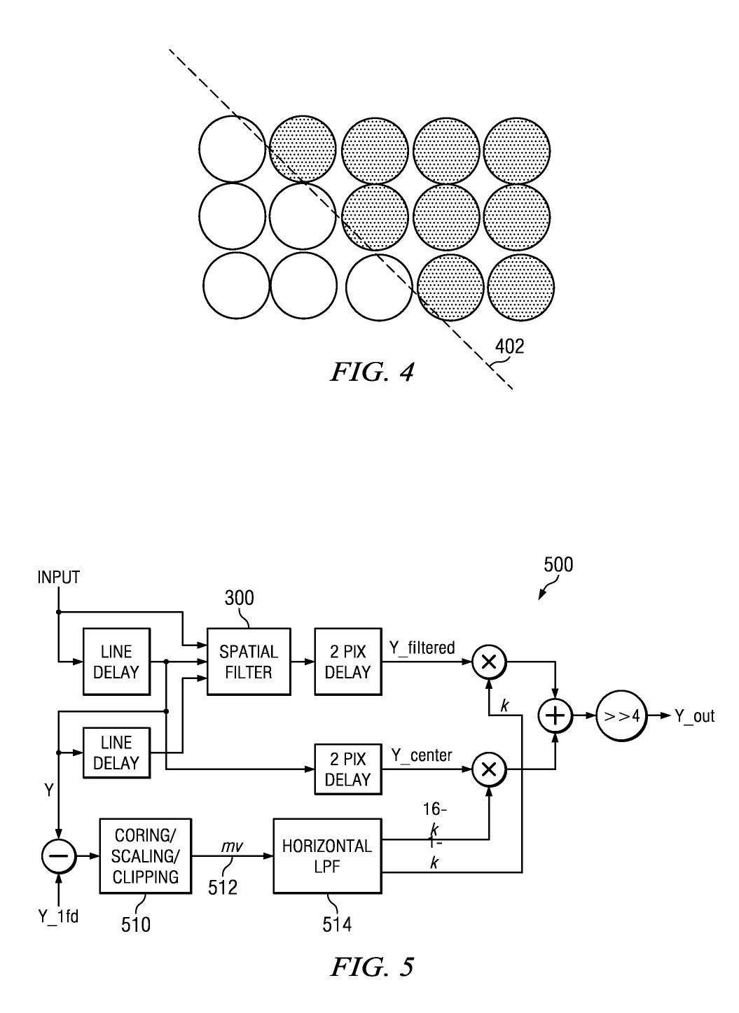

FIG. 4 is an illustration of bilateral filtering using a 3×5 window, where the values of the dark pixels are close to the center pixel value, while the values of the white pixels are relatively far away from the center pixel value. In this case, it is obvious that there is a negative 45 degree edge along the center pixel, as indicated at 402. When the bilateral filter is applied to the center pixel, the weights w[j][i] for those dark pixels will be 1 or 2, depending upon the closeness of these values with respect to the center pixel, while the weights for the white pixels will be 0, because the differences in values of the white pixels with respect to the center are large. Then, according to equation (4), the output of the bilateral filter Y_gnr will be an approximate average, or more accurately, a weighted average, of the dark pixels including the center pixel itself. Thus, noise will be significantly reduced while the edge will be essentially maintained.

Note that the performance of the bilateral filter heavily depends on how the two thresholds Thr_gnr1 and Thr_gnr2 are chosen. It is clear that smaller thresholds lead to less effectiveness of noise removal, but larger thresholds tend to remove the details or smooth the edges when removing noise.

Motion-Adaptive Spatial Noise Reduction

As mentioned above, no matter how well a spatial noise reduction filter is designed, it tends to soften pictures and even smooth out details and edges. Thus, it is usually preferred that the strength of the spatial noise filter be adaptive to motion values. By doing so, noise can efficiently be reduced while preserving the picture details. According to the discussions above, the final output is obtained through a blending expressed by equation (⁵);

Y_out[j][i]=(1−k)Y[j][i]+k·Y_filtered [j][i] (5)

where k is the blending factor determined by the measured motion values. The higher the amount of the motion, the greater the value of k. This means that the spatially filtered output weighs more in the blender. There are many ways to decide the blending factor. In one embodiment, a horizontal 5-tap low pass filter (1,2,2,2,1) is applied to the detected motion values as illustrated in Table 3.

TABLE 3
Blender logic in motion-adaptive spatial noise reduction.

1 /* Calculating luma and chroma difference */
2 Y_diff = (Y−Y_1fd); // Y_1fd is 1 frame delay with respect to Y
3 C_diff = (C−C_1fd); // C_1fd is 1 frame delay with respect to C
4
5 /* Coring and scaling */
6 if (Y_diff <= Y_mv_low_thr)
7 Y_diff_scaled = 0;
8 else
9 Y_diff_scaled=
((Y_diff − Y_mv_low_thr)*mv_scale_factor)>>3;
10
11 if (C_diff <= C_mv_low_thr)
12 C_diff_scaled = 0;
13 else
14 C_diff_scaled=
((C_diff − C_mv_low_thr)*mv_scale_factor)>>3;
15
16 /* Clipping */
17 Y_mv = Y_diff_scaled>15 ? 15 : Y_diff_scaled;
18 C_mv = C_diff_scaled>15 ? 15 : C_diff_scaled;
19
20 /* Obtain the motion value */
21 mv = max(Y_diff, C_diff);
22
23 /* Blending factor */
24 /* apply [1,2,2,2,1] low pass filter */
25 /* mv_4d/mv_3d/mv_2d/mv_1d are 4/3/2/1-pixel delayed with
respect to mv */
26 k = (mv_4d+(mv_3d<<1)+(mv_2d<<1)+(mv_1d<<1)+mv>>3;
27
28 /* Luma blending */
29 Y_out = ((16−k)*Y_center + k*Y_filtered)>>4;
30
31 /* Chroma blending */
32 C_out = ((16−k)*C_center + k*C_filtered)>>4;

In Table 3, Y_mv_low_thr and C_mv_low_thr are the coring thresholds for luma and chroma, respectively, and mv_scale_factor is the scaling factor, which is also a pre-defined constant. The motion value, mv, is the greater value of the measured motion values of luma and chroma. The blending factor, k, is obtained through low-pass filtering the motion values, as discussed above.

FIG. 5 is a block diagram of a motion-adaptive noise reduction module 500 that performs the logic of Table 3. Spatial noise filter block 300 is illustrated in FIG. 3. In this figure, only luma has been shown. Chroma is processed in the same fashion as luma as shown in Table 3. Motion detection logic 510 performs coring, scaling and clipping and provides a motion value 512 for a given pixel, as described in Table 3. Low pass filter 514 performs a 1,2,2,2,1 filter operation on the motion value to generate blending factor k, as described in Table 3. The final output pixel luma value Y_out is a blend of the original pixel Y_center and the filtered pixel Y_filtered, as described in Table 3.

A comprehensive hardware solution has been described for motion-adaptive spatial noise reduction for video signals targeting Gaussian noise and impulse noise. The adaptive noise reduction described herein can greatly reduce Gaussian noise and impulse noise while preserving picture details at the same time. Embodiments may be implemented as a pure spatial noise reduction or combined with a temporal filter to become a spatial-temporal noise reduction scheme. Embodiments may be used as both a pre-processing module in order to improve image quality and coding efficiency for video encoder and as a post-processing module in the video signal processing chain for better displayed image quality.

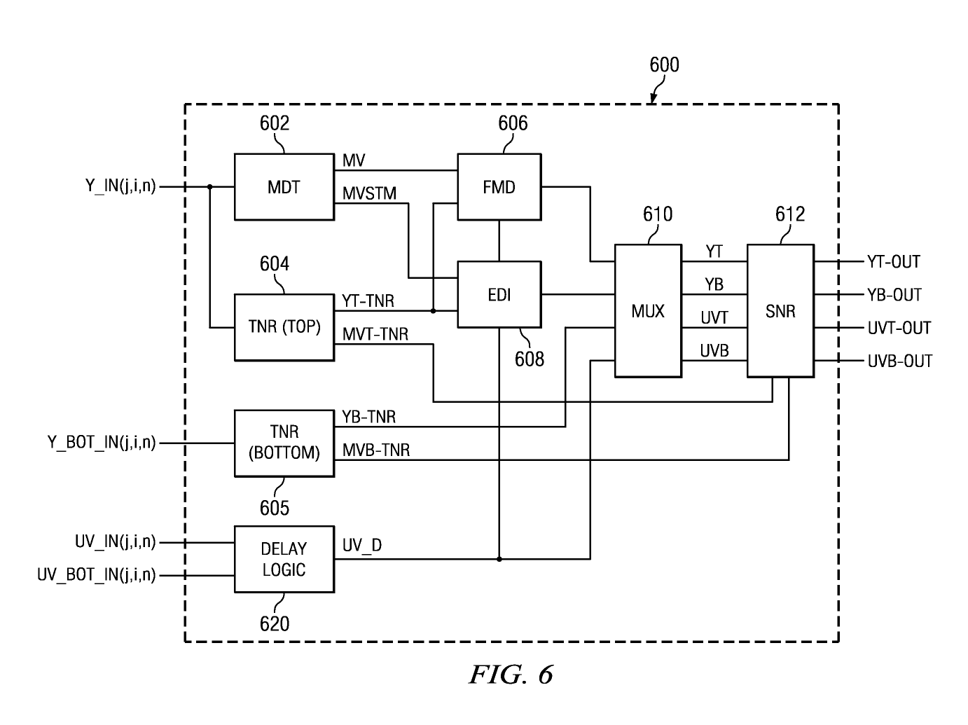

FIG. 6 is a block diagram of de-interlacing module 600 that includes an embodiment of the invention. De-interlacing module 600 may be part of video system 200 included within pre-processing component 212 for a system that receives broadcast TV video, such as a set-top box for cable or satellite video capture sources. Historically, analog TV signals were formatted in an interlaced manner in which a first frame contained odd lines of raster data and a second frame contains the related even lines of raster data. Cable and satellite systems therefore send interlaced TV signals on some channels. For digital TV systems, these interlaced video signals are converted to progressive frame signals in which each frame includes all of the pixel data for each frame. In order to convert from interlaced to progressive frame data, motion adaptive interpolation may be used to fill in the missing odd or even lines in each interlaced frame. For this reason, de-interlacing module 600 includes motion detection module 602. Motion detection for conversion of frame interlaced frames to progressive frames is well known and therefore will not be described in detail herein.

In this embodiment, two temporal noise reduction modules (TNR) 604, 605 are included that also perform motion detection. When a progressive frame video signal is received from the video source, both TNR modules output two motion values, mv_tnr_top, mv_tnr_bot, to spatial noise reduction (SNR) module 612. When an interlaced video signal is received, TNR 604 is used for temporal noise reduction; TNR 605 is used to generate motion value, mv_tnr, for the SNR module.

The fact that a motion detection module is typically available in a de-interlacing module allows motion adaptive noise reduction to be performed without the need for additional motion detection logic. However, in a system that does not already have motion detection logic available, then a motion detection logic module will be need to be included in order to do motion adaptive noise reduction.

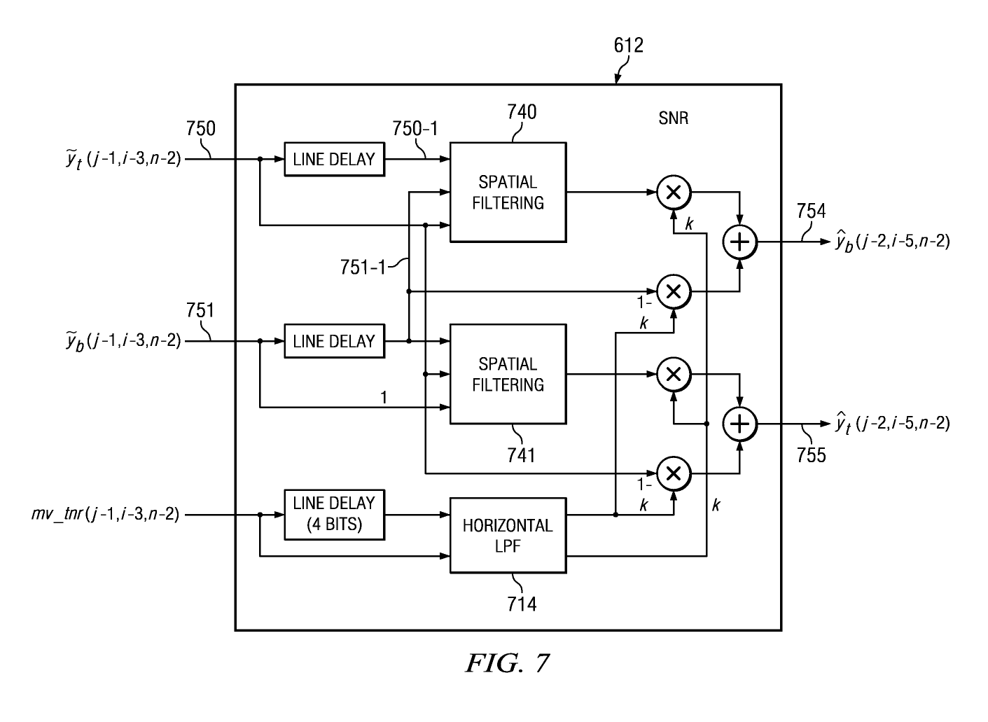

FIG. 7 is a block diagram of SNR module 612. In FIG. 6, the inputs to SNR module 612 are top and bottom lines 750, 751, so there are two spatial filters running in parallel to perform filtering on the two lines. The output is two lines as well, top line 755 and bottom line 754. SNR modul 612 is similar to motion adaptive noise reduction module 500 but has two spatial filters 740, 741 operating in parallel. Each spatial filter 740, 741 is similar in operation to spatial filter 300, as described above. SNR module 612 operates in a similar manner as described with regard to FIG. 5 to provide blending of the outputs of each spatial filter with the unfiltered input based on blending factor k derived by horizontal low pass filter 714. However, in this embodiment, the output of top spatial filter 740 is blended with the unfiltered bottom line signal 751 to produce bottom line output 754 while the output of bottom spatial filter 741 is blended with the unfiltered top line signal 750 to produce top line output signal 755. This is because the inputs to top spatial filter 740 are three lines: top line 750, delayed by one line bottom line 751-1, and delayed by one line top line 750-1, which is also a top line. Then the output from filter 740 is blended with delayed bottom line 751-1 to generate a bottom line. The bottom spatial filter 741 works in a similar fashion. In this embodiment, the output signals correspond to pixel index (j-2, i-5, n-2); however, in other embodiments the indexing may be different due to different selections of line buffers and pipeline stages.

There are actually two similar SNR modules in this embodiment; one for luma (y) and one for chroma (uv). The general operation is illustrated by equations (6), where y_{f} and uv_{f} are the filtered components.

ŷ(j,i,n)=(1−k)\tilde{y}+k·\tilde{y}_{f}ûv(j,i,n)=(1−k)ũv+k·ũv_{f} (6)

In another embodiment, one instance of a spatial filter may be used in SNR 612, but the throughput would be reduced by half.

Referring again to FIG. 6, edge directed interpolation (EDI) module 608 produces edge detection information for use in pixel interpolation using motion information (MVstm) from MDT 602, temporal filtered line information YT_TNR from TNR 604, and chroma information from delay logic 620. (FMD) module 606 performs film mode detection that is useful optimizing a video stream that was converted from 24 frame per second film format to 60 fields per second TV format. Multiplexor (MUX) module 610 receives information for two-lines of data from the various modules and forms a frame by adjusting the order of the two lines (which is the top line and which is the bottom line depending on the control signal obtained from the input) and the FMD module output. The outputs are then sent to SNR module 612 for noise reduction.

System Example

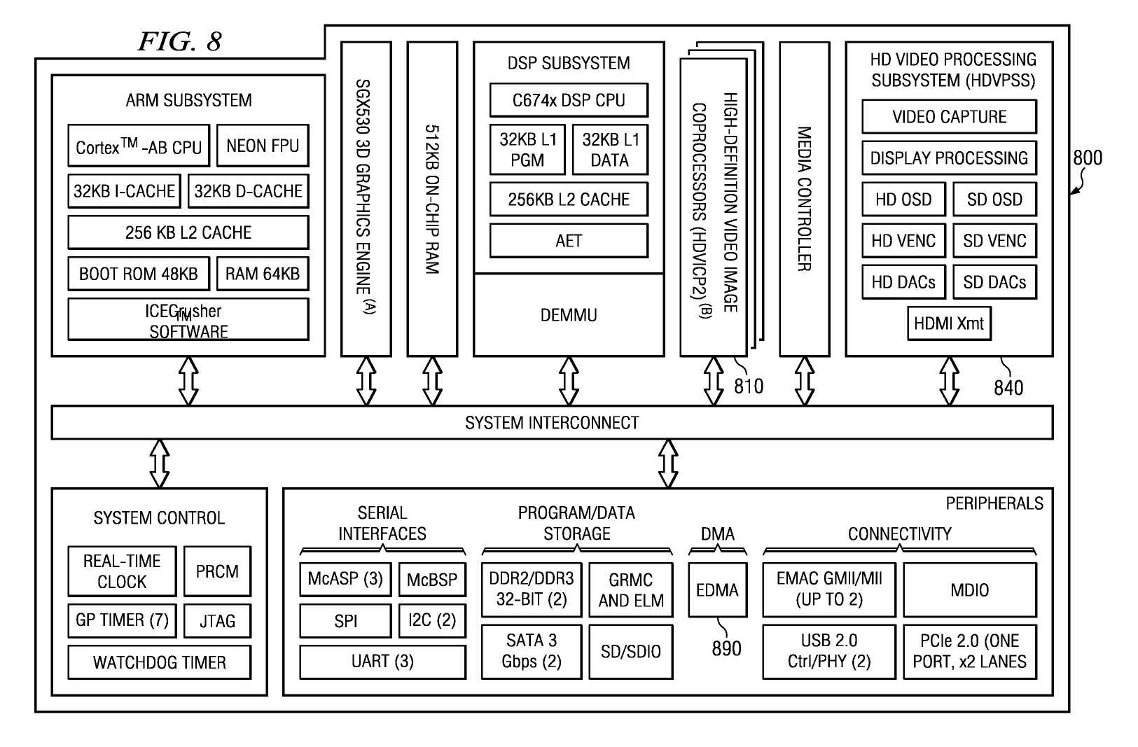

FIG. 8 is a block diagram of an example SoC 800 that may include an embodiment of the invention. This example SoC is representative of one of a family of DaVinci™ Digital Media Processors, available from Texas Instruments, Inc. This example is described in more detail in “TMS320DM816x DaVinci Digital Media Processors Data Sheet, SPRS614”, MARCH 2011 which is incorporated by reference and is described briefly below.

The Digital Media Processors (DMP) 800 is a highly-integrated, programmable platform that meets the processing needs of applications such as the following: Video Encode/Decode/Transcode/Transrate, Video Security, Video Conferencing, Video Infrastructure, Media Server, and Digital Signage, etc. DMP 800 may include multiple operating systems support, multiple user interfaces, and high processing performance through the flexibility of a fully integrated mixed processor solution. The device combines multiple processing cores with shared memory for programmable video and audio processing with a highly-integrated peripheral set on common integrated substrate.

HD Video Processing Subsystem (HDVPSS) 840 includes multiple video input ports that operate in conjunction with DMA engine 890 to receive streams of video data. HDVPSS 840 preprocesses the video streams prior to encoding by coprocessor 810. HDVPSS includes an embodiment of the motion-adaptive noise reduction scheme described above that is used to reduce noise in the video stream prior to encoding. A de-interlacing module with motion-adaptive noise reduction similar to module 600 of FIG. 6 is included within HDVPSS 840.

DMP 800 may include multiple high-definition video/imaging coprocessors (HDVICP2) 810. Each coprocessor can perform a single 1080p60 H.264 encode or decode or multiple lower resolution or frame rate encodes/decodes. Multichannel HD-to-HD or HD-to-SD transcoding along with multi-coding are also possible.

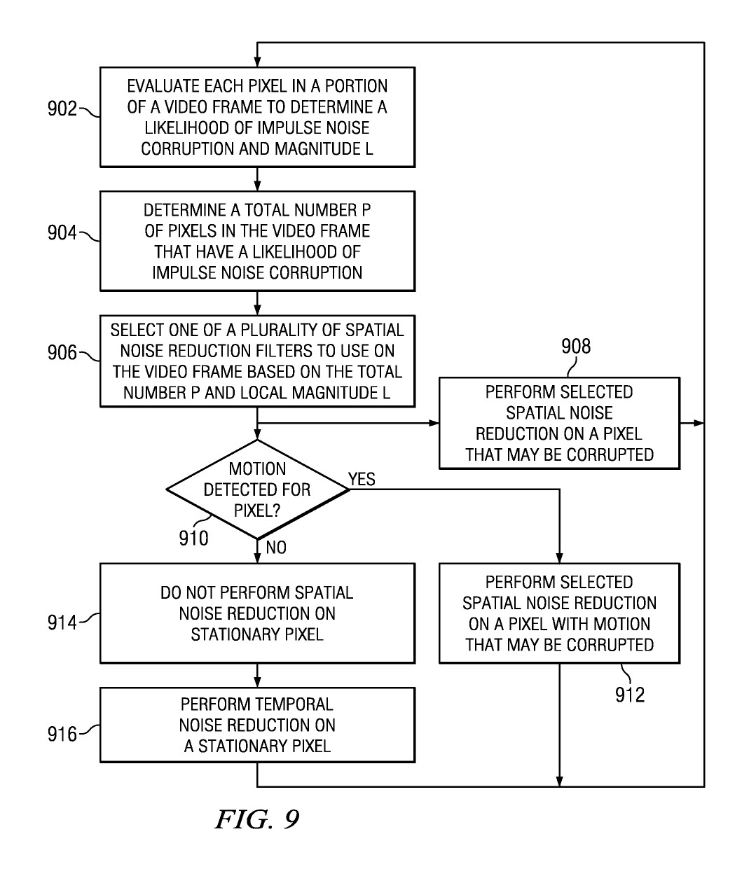

FIG. 9 is a flow chart illustrating adaptive noise reduction as described herein. For each frame in a stream of video data, each pixel in a portion of the video frame is evaluated 902 to determine a likelihood of impulse noise corruption to each pixel. As described above, any of several measurement schemes may be used to determine if it is likely that a pixel has been corrupted. For each pixel in which possible noise corruption is detected, the local magnitude is determined as a value L, where L is determined by how many pixels in a measuring window have greater differences than a preselected threshold from the center pixel.

A total number P of pixels in the video frame that have a likelihood of impulse noise corruption is determined 904 by simply adding up the number of pixels that have been indicated as being possibly corrupted in the frame or in the portion of a frame that is being processed.

One of a plurality of spatial noise reduction filters is selected 906 to use on the video frame based on the total number P and the local magnitude L. As described above, one several filter modes may be selected based on the global value of likely noise corruption. For example, if P is below a low threshold, then the filter mode selected may be a simple pass through with no filtering or a Gaussian noise reduction filter may be selected. If P is above the low threshold, a median filter may be selected if the local magnitude L is below a magnitude threshold. If P is above the low-threshold and local magnitude L is above the magnitude threshold, then a tri-state filter may be selected.

In some embodiments, at this point, the selected filter is performed 908 on each pixel for which a determination 902 of possible corruption was made. In this manner, a suitable spatial noise filter is adaptively selected for each frame based on the total globally detected noise in that frame and the magnitude of the local corruption of the pixel. Adjacent frames may have different spatial noise filters selected for use within the frame.

In other embodiments, motion detection 910 on each pixel is performed by comparing adjacent frames. In this case, only pixels for which motion has been detected will be subjected 912 to spatial noise filtering. If no motion, or very little motion, has been detected 910 for a pixel, then no spatial noise filtering is performed 914 on that pixel. However, within areas on no or little motion, temporal noise reduction filtering may be performed 916. A blending factor k may be produced based on the amount of motion of a pixel and the spatial filtering 912 for the pixel may then be weighted based on the blending factor k.

In this manner, a suitable spatial noise filter is adaptively selected for each frame based on the total globally detected noise in that frame. Adjacent frames may have different spatial noise filters selected for use within the frame. Furthermore, motion-adaptive noise reduction filtering is performed such that spatial noise reduction filtering is performed using the selected filter in areas of each frame for which motion has been detected and temporal noise reduction filtering is performed in areas of the frame in which little or no motion has been detected.

In another embodiment of the invention, motion adaptive noise reduction may be performed using a default spatial noise reduction filter; in other words, the global determination function 904 and selection function 906 may be skipped.

Other Embodiments

While the invention has been described with reference to illustrative embodiments, this description is not intended to be construed in a limiting sense. Various other embodiments of the invention will be apparent to persons skilled in the art upon reference to this description. For example, various types of filters now known or later developed may be included in an embodiment in which a particular filter is selected on a frame by frame basis based on the total amount of noise that is measured to be in a given frame.

Motion detection used for motion adaptive interpolation has been described and used in the examples herein. Other embodiments may use other schemes either now known or later developed for determining and measuring frame to frame pixel motion.

Impulse noise measurement on a pixel by pixel basis is described herein. Other embodiments may use other noise measurement schemes either now known or later developed to determine which noise filter to select for use on a given frame of video data.

While the H.264 video coding standard may be used for encoding a video stream that has been adaptively noise reduced as described herein, embodiments for other video coding standards will be understood by one of ordinary skill in the art. Accordingly, embodiments of the invention should not be considered limited to the H.264 video coding standard.

Embodiments of the noise filters and methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized accelerators. A stored program in an onboard or external (flash EEP) ROM or FRAM may be used to implement aspects of the video signal processing. Analog-to-digital converters and digital-to-analog converters provide coupling to the real world, modulators and demodulators (plus antennas for air interfaces) can provide coupling for waveform reception of video data being broadcast over the air by satellite, TV stations, cellular networks, etc or via wired networks such as the Internet and cable TV.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for reducing noise in a video signal, the method comprising:
evaluating each pixel in a portion of a video frame to determine a likelihood L of impulse noise corruption to each pixel;
determining a total number P of pixels in the video frame that have a likelihood of impulse noise corruption;
selecting one of a plurality of spatial noise reduction filters to use on the video frame based on the total number P; and
applying the selected spatial noise reduction filter to a portion of pixels in the video frame.

2. The method of claim 1, wherein selecting one of a plurality of spatial noise reduction filters to use on the video frame is based on the total number P and on the likelihood L of impulse noise corruption to a current pixel.

3. The method of claim 1, further comprising:
determining a motion value for each pixel in the portion of the video frame; and
inhibiting spatial noise reduction filtering of each pixel that has a low motion value.

4. The method of claim 1, wherein selecting a spatial noise reduction filter comprises selecting a Gaussian noise reduction filter when the total number P of likely impulse noise corrupted pixels is below a threshold.

5. The method of claim 1, further comprising defining a filter mode for the frame according to a set of thresholds by ranking the total number P of likely corrupted pixels according to the set of thresholds; and
wherein selecting one of a plurality of spatial noise reduction filters to use on the video frame is based on the filter mode for the frame.

6. The method of claim 3, further comprising applying temporal noise reduction to a likely corrupted pixel when the pixel has a motion value of zero.

7. The method of claim 1, further comprising encoding the video frame after applying the selected spatial filter.

8. The method of claim 1, further comprising applying the selected spatial filter to the frame after decoding the video frame to reduce noise prior to being displayed.

9. A method for reducing noise in a video signal, the method comprising:
evaluating each pixel in a portion of a video frame to determine a likelihood L of impulse noise corruption to each pixel;
determining a motion value for each pixel in the portion of the video frame; and
inhibiting spatial noise reduction filtering of each pixel that has a low motion value.

10. The method of claim 9, further comprising:
determining a total number P of pixels in the video frame that have a likelihood of impulse noise corruption;
selecting one of a plurality of spatial noise reduction filters to use on the video frame based on the total number P and on the likelihood L of impulse noise corruption to a current pixel; and
applying the selected spatial noise reduction filter to a portion of pixels in the video frame.

11. The method of claim 10, wherein selecting a spatial noise reduction filter comprises selecting a Gaussian noise reduction filter when the total number P of likely impulse noise corrupted pixels is below a threshold.

12. The method of claim 10, further comprising defining a filter mode for the frame according to a set of thresholds by ranking the total number P of likely corrupted pixels according to the set of thresholds; and
wherein selecting one of a plurality of spatial noise reduction filters to use on the video frame is based on the filter mode for the frame.

13. The method of claim 9, further comprising applying temporal noise reduction to a likely corrupted pixel when the pixel has a motion value of zero.

14. The method of claim 10, further comprising encoding the video frame after applying the selected spatial filter.

15. The method of claim 10, further comprising applying the selected spatial filter to the frame after decoding the video frame to reduce noise prior to being displayed.

16. A video processing system comprising:
an adaptive spatial noise reduction filter module, wherein the adaptive spatial noise reduction filter module comprises:
an input to receive a stream of video frames;
measurement logic configured to determine a likelihood of impulse noise corruption to each pixel in a portion of a video frame in the stream of video frames;
a summer coupled to the measurement logic, wherein the summer is configured to determine a total number P of pixels in the video frame that have a likelihood of impulse noise corruption;
a plurality of spatial noise reduction filter logics; and
selection logic coupled to the plurality of spatial noise reduction filter logics, wherein the selection logic is configured to select one of the plurality of spatial noise reduction filter logics to use on the video frame based on the total number P.

17. The video processing system of claim 16, further comprising:
motion detection logic configured to determine a motion value for each pixel in the portion of the video frame; and
wherein the selection logic is configured to inhibit spatial noise reduction filtering of each pixel that has a low motion value.

18. The video processing system of claim 17, further comprising a temporal noise reduction module coupled to the motion detection logic, wherein the temporal noise reduction module is configured to apply temporal noise reduction to a likely corrupted pixel only when the pixel has a motion value of zero.

19. The video processing system of 16, wherein the adaptive spatial noise reduction filter module is comprised within a pre-processing module whose output is coupled to an encoding module.

20. The video processing system of 16, wherein the adaptive spatial noise reduction filter module is comprised within a post-processing module whose input is coupled to a decoding module.
